(19) United States
(12) Patent Application Publication
(10) Pub. No.: US 2019/0253879 A1
(43) Pub. Date: Aug. 15, 2019

(54) COMMUNICATION APPARATUS, METHOD OF CONTROLLING THE SAME, AND STORAGE MEDIUM

(71) Applicant: CANON KABUSHIKI KAISHA, Tokyo (JP)

(72) Inventor: Masato Tsuchiya, Kashiwa-shi (JP)

(21) Appl. No.: 16/260,587

(22) Filed: Jan. 29, 2019

(30) Foreign Application Priority Data
Feb. 14, 2018 (JP) 2018-024340

(51) Int. Cl. H04W 8/26; H04W 8/00; H04W 76/14; H04N 1/00; G06F 3/12

(52) U.S. Cl. CPC H04W 8/26; H04W 8/005; H04W 76/14; H04W 84/12; G06F 3/1236; G06F 3/1214; G06F 3/1292; H04N 1/00307

(57) ABSTRACT

A communication apparatus obtains identification information of a first user that operates the operation device, sets a first SSID associated with the identification information of the first user as an SSID to be used in the direct wireless communication, and, if communication using the first SSID is not being executed when identification information of a second user that operates the operation device is obtained, changes the SSID to be used in the direct wireless communication from the first SSID to a second SSID associated with the identification information of the second user, and, if communication using the first SSID is being executed, not change the SSID to be used in the direct wireless communication.

### BACKGROUND OF THE INVENTION

### Field of the Invention

The present invention relates to a communication apparatus, a method of controlling the same, and a storage medium.

### Description of the Related Art

In recent years, home electric appliances and office equipment often have a wireless communication function, and are connected to a home LAN or the Internet. Image forming apparatuses such as printers and multi-function peripheral are no exception, and there is increasing demand for wirelessly connecting to information terminals such as mobile terminals and laptop computers to perform processing such as inputting print jobs to the image forming apparatuses from these information terminals and configuring device settings.

There are generally two ways of using a wireless connection. One way is once-off usage that involves establishing a temporary wireless connection and, when usage of the wireless connection ends, discarding connection information (network identifier and passphrase) that is required to establish the wireless connection but is no longer useful. In this case, a random number is often added to the connection information such as the network identifier and the passphrase. Another way is permanent usage that involves keeping a terminal that is always used at a particular location in a constantly connected state. In this case, normally, the network identifier is fixed, and does not change due to factors such as the information processing apparatus being powered again. With respect to the fixed network identifier, mobile terminals have a function of storing the connection information of an access point that has been connected to, and automatically reconnect.

In this regard, with respect to information processing apparatuses that will possibly be used by a plurality of users, Japanese Patent Laid-Open No. 2016-201701 also proposes a technology for switching network identifiers through association with the user that is logged in. With both ways of using the wireless connection given above, there is a need to change the connection information such as the network identifier and passphrase to cope with a plurality of users. However, at the time of switching the connection information, the wireless terminal that is currently connected needs to disconnect and, depending to the timing of a user action, ongoing communication may be interrupted.

At the time that the wireless communication connection is disconnected from one side by a user action, the connected terminal on the other side could possibly be performing some sort of communication, in which case the communication that is in progress will be disconnected.

### SUMMARY OF THE INVENTION

An aspect of the present invention is to eliminate the above-mentioned problem with conventional technology.

A feature of the present invention is to provide a technique that solves the above-mentioned problem by inquiring with a user, in the case where a request to disconnect wireless connection is issued, about whether to disconnect the wireless connection, in the case where communication is being performed using that wireless connection.

According to a first aspect of the present invention, there is provided a communication apparatus capable of direct wireless communication for wireless LAN communication with an external apparatus without involving a relay apparatus, the communication apparatus comprising: an operation device that accepts an operation of a user; a memory device that stores a set of instructions; at least one processor that executes the instructions stored in the memory device to cause the communication apparatus to function as: an obtaining unit configured to obtain identification information of a first user that operates the operation device; a setting unit configured to set a first SSID associated with the identification information of the first user as an SSID to be used in the direct wireless communication; and a control unit configured to, if communication using the first SSID is not being executed when identification information of a second user that operates the operation device is obtained, change the SSID to be used in the direct wireless communication from the first SSID to a second SSID associated with the identification information of the second user, and if the communication using the first SSID is being executed, not change the SSID to be used in the direct wireless communication.

According to a second aspect of the present invention, there is provided a method of controlling a communication apparatus capable of direct wireless communication for wireless LAN communication with an external apparatus without involving a relay apparatus and having an operation device that accepts an operation of a user, the method comprising: obtaining identification information of a first user that operates the operation device; setting a first SSID associated with the identification information of the first user as an SSID to be used in the direct wireless communication; and if communication using the first SSID is not being executed when identification information of a second user that operates the operation device is obtained, changing the SSID to be used in the direct wireless communication from the first SSID to a second SSID associated with the identification information of the second user, and if the communication using the first SSID is being executed, not changing the SSID to be used in the direct wireless communication.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram illustrating the configuration of an information processing system according to an embodiment.

FIG. 2A is a block diagram for describing the hardware configuration of an MFP according to the embodiment.

FIG. 2B is a diagram illustrating an example of a table that is saved on an HDD according to the embodiment.

FIG. 3 is a block diagram for explaining a software configuration of the MFP according to the embodiment.

FIG. 4 is a flowchart for describing processing that is executed by the MFP according to the embodiment.

FIG. 5 is a diagram for describing a user interface (UI) of the MFP according to the embodiment and transition of a UI screen thereof.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

There are generally a number of forms of wireless connection, and the present invention is not particularly limited, and encompasses forms from short-range communication such as Wi-Fi, BLE and NFC to long-distance communication such as LTE, 3G and 4G, and also recent IoT communication such as Cat-M1 and NB-IoT.

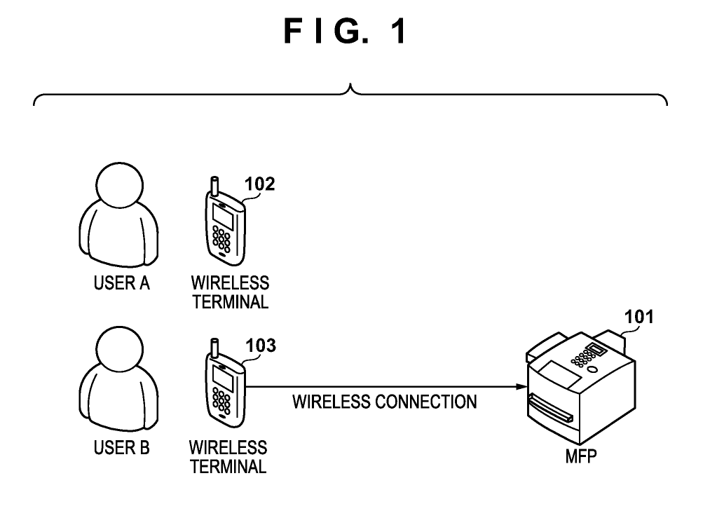

FIG. 1 is a diagram for describing the configuration of an information processing system according to an embodiment.

In an environment of the embodiment, there exists an MFP 101 having a wireless communication function and a wireless terminal (mobile terminal) 103 of a user B that has established a P2P connection (P2P mode) through wireless communication. Furthermore, there exists a wireless terminal 102 (mobile terminal) of a user A that is attempting to establish a wireless P2P connection with the MFP 101. Note that although the embodiment will be described taking the case where one of the wireless communication devices that establish a wireless P2P connection is an MFP (image forming apparatus) as an example, the present invention is not limited thereto. For example, an information processing apparatus such as a personal computer or a mobile terminal may be used rather than the MFP. Also, generally, in wireless connection, there is a limit to the number of terminals that can be connected at the same time, with this being determined by hardware and software performance and constraints. In the embodiment, the maximum number of devices that is connectable is given as one.

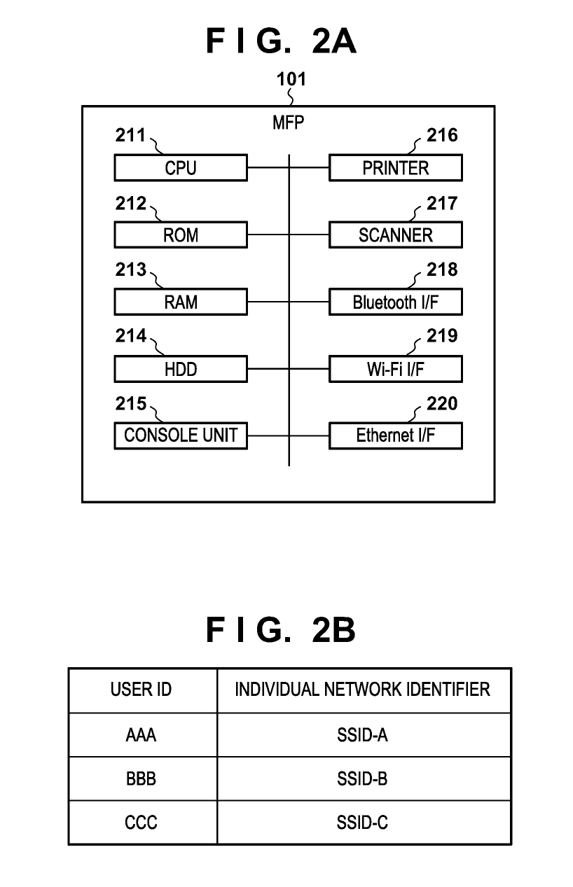

Next, the hardware configuration of the MFP 101 according to the embodiment will be described, with reference to FIG. 2A.

FIG. 2A is a block diagram for describing the hardware configuration of the MFP 101 according to the embodiment.

A CPU 211 controls the operations of the entire MFP 101. The CPU 211 executes a boot program stored in a ROM 212 to deploy a control program that is stored in an HDD 214 to a RAM 213, and performs various controls such as reading control and transmission control by executing the deployed program. The RAM 213 is a volatile memory that is applied to use such as a work area for the CPU 211 to execute various programs. The HDD 214 stores image data, various programs and the like. A console unit 215 is provided with a display that operates as a touch panel operable by the user's fingers. A printer 216 prints an image that is based on image data transferred via an internal bus on a sheet. A scanner 217 reads an image of an original and generates image data. A Bluetooth™ I/F (interface) 218 is an interface for performing wireless communication compliant with Bluetooth standards, and communicates with other devices having a Bluetooth I/F. In the embodiment, the MFP 101 communicates with wireless terminals in compliance with Bluetooth standards. A Wi-Fi I/F 219 and an Ethernet™ I/F 220 are NICs (Network Interface Cards) for respectively connecting to a network in a wireless manner and a wired manner. These constituent elements denoted by reference numerals 211 to 219 are connected via the internal bus, and are able to exchange data with each other.

FIG. 2B is a diagram illustrating an example of a table that is saved in the HDD 214 according to the embodiment.

This table stores information that associates the user information of a login user with a network identifier unique to the user.

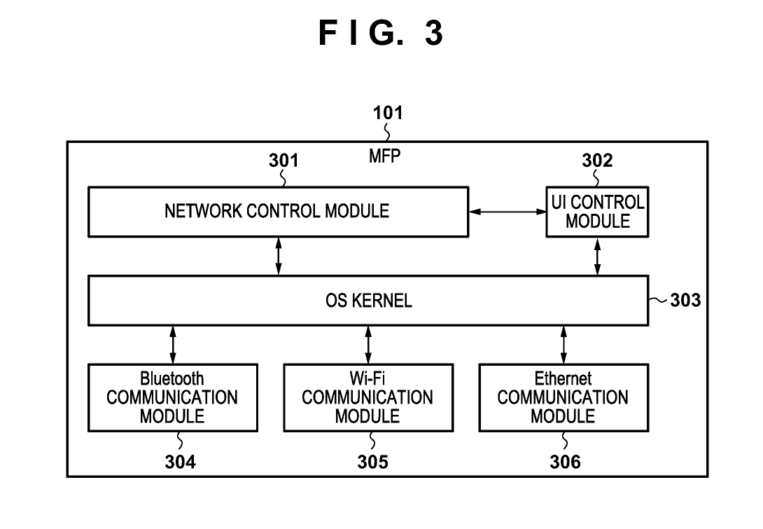

Next, the software configuration of the MFP 101 according to the embodiment will be described with reference to FIG. 3.

FIG. 3 is a block diagram showing the software configuration of the MFP 101 according to the embodiment.

A Wi-Fi communication module 305 is a module for controlling the Wi-Fi I/F 219, and a Bluetooth communication module 304 is a module for controlling the Bluetooth I/F 218. Similarly, an Ethernet communication module 306 controls the Ethernet I/F 220. These modules are controlled by an OS kernel 303. A network control module 301 operates both the Bluetooth and Wi-Fi communication modules 304, 305 via the OS kernel 303. Also, the network control module 301 manages the current network settings, and manages whether or not the various communication configurations, namely, Ethernet (cable LAN), wireless LAN and wireless P2P connection, are enabled. Furthermore, the network control module 301 performs transfer of information with a UI control module 302, and changes the display of the UI (the console unit 215) or conversely performs network control in response to an operation request from the UI. Note that the function of each constituent element shown in FIG. 3 is realized by the CPU 211 executing a program deployed in the above-mentioned RAM 213.

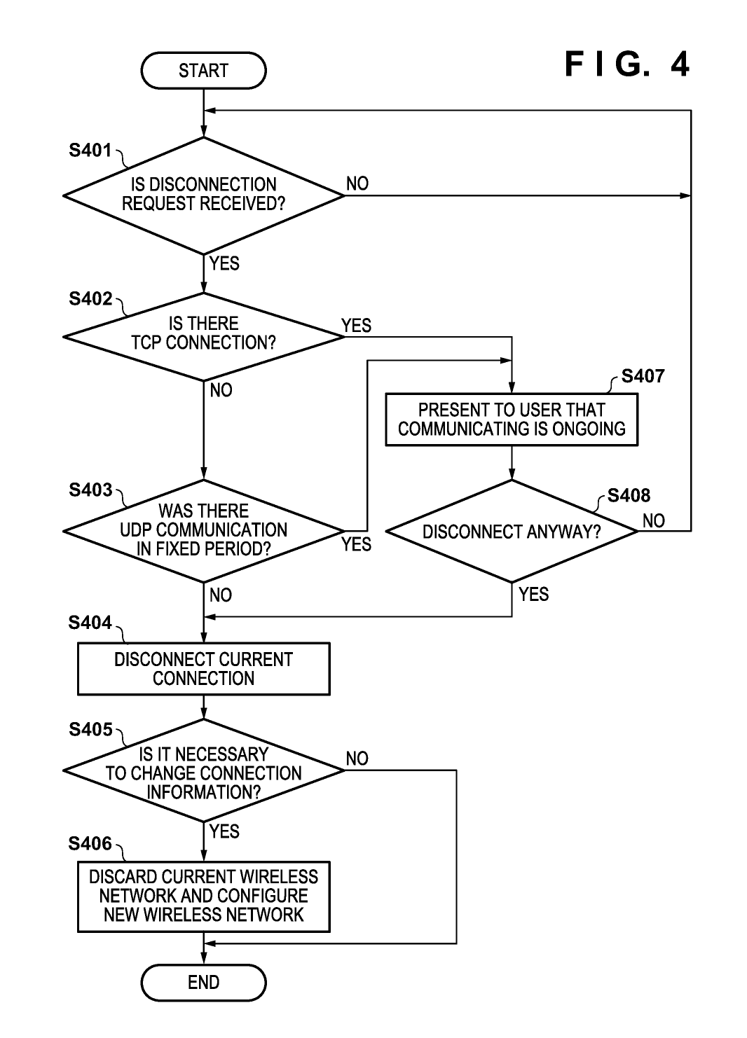

FIG. 4 is a flowchart for describing processing that is executed by the MFP 101 according to the embodiment. This flowchart shows processing for determining, after the MFP 101 has established a wireless P2P connection with a wireless terminal, whether the MFP 101 is currently communicating with the connected wireless terminal, when a disconnection request is generated due to an action of the user. Note that the processing shown in this flowchart is achieved by the CPU 211 executing the program deployed in the RAM 213.

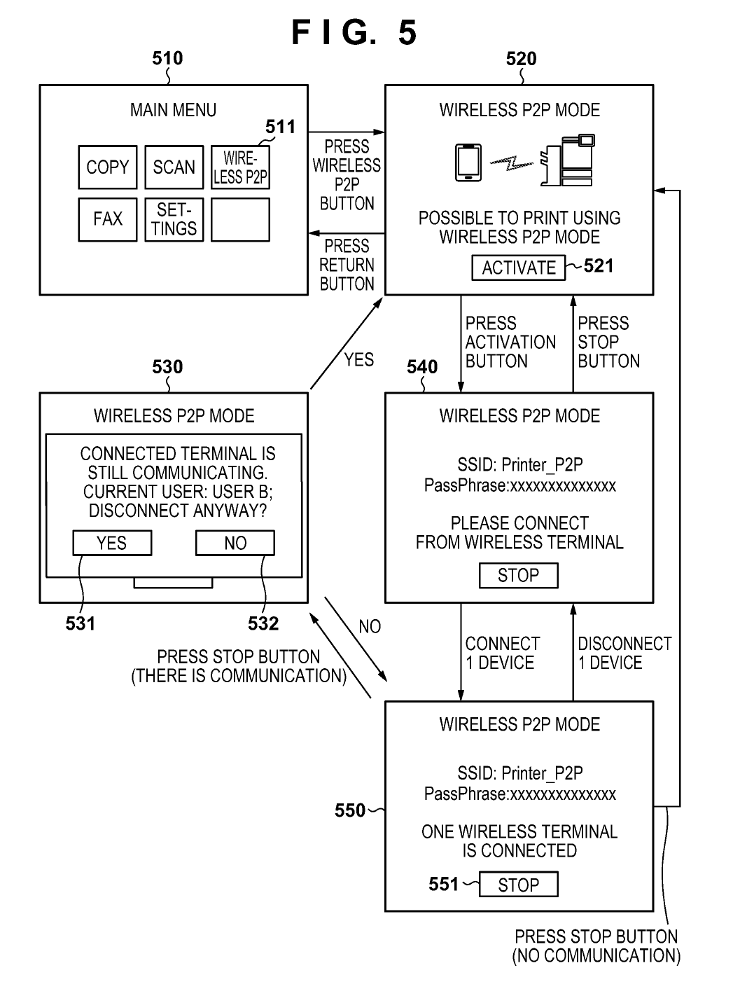

Here, a user interface (UI) of the MFP 101 according to the embodiment and transition of a UI screen thereof will be described, with reference to FIG. 5. FIG. 5 depicts a view illustrating an example of a screen displayed on a display of the console unit of the MFP according to the embodiment and transition of the screen.

This processing is started in a state where the MFP 101 and the wireless terminal 103 are wirelessly connected, and a screen 550 in FIG. 5 is displayed on a local user interface (the console unit 215) of the MFP 101. The SSID of the MFP 101 and authentication information (passphrase) are displayed on this screen 550, and, furthermore, an indication that the MFP 101 is wirelessly connected to one wireless terminal is also displayed.

A disconnection request is generated when the user presses a stop button 551 on this screen 550, and, in step S401, the CPU 211 determines that a disconnection request has been received with respect to an existing wireless connection, and advances the processing to step S402. In step S402, the CPU 211 determines whether communication is in progress. Although there are conceivably a number of methods of determining whether communication is in progress, the TCP/IP layer is the most suitable for detecting the existence of communication linked to a user operation, regardless of the application that is being used. In view of this, first the CPU 211 determines in step S402 whether when there is a TCP connection, and, if it is determined in the negative, advances the processing to step S403, and determines whether there was UDP communication within a most recent fixed period. If it is determined in steps S402 and S403 that neither TCP communication nor UDP communication has been performed, it is determined that disconnection can be performed, and the processing advances to step S404, where the CPU 211 disconnects the current wireless P2P connection, and thereafter advances the processing to step S405.

On the other hand, if either TCP communication or UDP communication is still being executed, the processing advances to step S407, where the CPU 211 presents the user with an indication that communication is still ongoing. At this time, the local user interface transitions to a screen 530 of FIG. 5. The CPU 211 at this time obtains information on the user that is currently using the MFP 101, with reference to FIG. 2B. Specifically, the CPU 211 specifies the user ID that was logged in when wireless P2P connection was started, based on the network identifier of the network on which wireless communication is currently being performed. The CPU 211 then displays the username (“user B” in the example in FIG. 5) of the specified user ID on a pop-up screen displayed on the screen 530, and inquires with the new user about whether or not to disconnect the wireless communication. In the example in FIG. 5, the screen 550 transitions to the screen 530 when the user A presses the stop button 551 on the screen 550, and a pop-up screen on which it is indicated that the user B of the wireless terminal 103 is currently in communication is displayed on the screen 530. If the user A presses a YES button 531 on this screen 530, that is, if the user A instructs to disconnect the current wireless connection, the processing advances from step S408 to step S404, and the wireless P2P connection is disconnected. On the other hand, if the user A presses a NO button 532, the progressing advances from step S408 to step S401, and the CPU 211 returns to the state of the waiting for a disconnection request, with the wireless P2P connection maintained. At this time, a screen returns to the screen 550 that was displayed before the stop button 551 was pressed.

The processing advances to step S405 after disconnecting the current connection in step S404, and the CPU 211 determines whether it is necessary to change the wireless connection information (network identifier and passphrase) currently being used. This determination includes processing for comparing whether wireless connection information associated with the new login user differs from the current wireless connection information. Here, in the case of differing, that is, if it is determined that the wireless connection information needs to be changed, the processing advances to step S406, where the CPU 211 discards the wireless network that is currently configured, recreates a network using wireless connection information associated with the new login user, and ends this processing. On the other hand, the CPU 211 ends this processing, when it is determined in step S405 that the wireless connection information currently being used does not need to be changed.

In FIG. 5, when the user presses a wireless P2P application button 511 on a main menu screen 510, the UI screen shifts to a wireless P2P connection management screen 520. There is a wireless P2P connection activation button 521 on this screen 520, and a wireless P2P connection is activated by the user pressing this activation button 521, and the MFP 101 enters a standby state for accepting a connection request from a partner terminal such as a wireless terminal.

When the activation button 521 is pressed and activation of wireless P2P connection is completed, the UI screen shifts to a wireless P2P connection standby screen 540 that displays the network identifier (SSID, etc.) and authentication information (passphrase, etc.) for establishing a wireless P2P connection. In the state where this screen 540 is displayed, radio waves for accepting a wireless P2P connection are sent out, and a connection request from a partner terminal can be accepted. The UI screen shifts to the connected screen 550 when the partner terminal is connected, and an indication that the partner terminal is currently connected is displayed on this screen 550. The UI screen returns to the original screen 540 when one partner terminal that was connected is disconnected in the state where this screen 550 is displayed.

On the other hand, if the stop button 551 is pressed on the screen 550 when connected, a disconnection request is generated, and it is determined in the affirmative in step S401 of FIG. 4. In this case, it is furthermore confirmed, at that point in time, whether communication by TCP or UDP is being performed (step S402, step S403). If there is no communication by TCP or UDP, the wireless P2P connection is stopped directly, and the MFP 101 shifts to the pre-activation state in which a connection request cannot be received from a partner terminal. At this time, the screen 550 transitions to the pre-activation screen 520.

On the other hand, if there is communication by TCP or UDP, the UI screen shifts to the screen 530 in order to present the user with an indication that communication is still ongoing (step S405), and inquires with the user about whether to still disconnect the wireless connection (step S406). An indication that communication with the user B of the wireless terminal 103 is ongoing is displayed on the screen 530. If, for example, another user A presses the YES button 531 on this screen 530, processing for disconnecting the current connection is performed (step S404), the wireless P2P connection is stopped and the UI screen shifts to the screen 520. On the other hand, when a user presses the NO button 532 on the screen 530, the UI screen returns to the screen 550 that was displayed before the stop button 551 was pressed.

According to the present embodiment as described above, it is possible to prevent a wireless connection being disconnected even though communication using the wireless connection is still ongoing when a wireless communication disconnection request is generated.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-024340, filed Feb. 14, 2018, which is hereby incorporated by reference herein in its entirety.

What is claimed is:

1. A communication apparatus capable of direct wireless communication for wireless LAN communication with an external apparatus without involving a relay apparatus, the communication apparatus comprising:
an operation device that accepts an operation of a user;
a memory device that stores a set of instructions;
at least one processor that executes the instructions stored in the memory device to cause the communication apparatus to function as:
an obtaining unit configured to obtain identification information of a first user that operates the operation device;
a setting unit configured to set a first SSID associated with the identification information of the first user as an SSID to be used in the direct wireless communication; and
a control unit configured to, if communication using the first SSID is not being executed when identification information of a second user that operates the operation device is obtained, change the SSID to be used in the direct wireless communication from the first SSID to a second SSID associated with the identification information of the second user, and if the communication using the first SSID is being executed, not change the SSID to be used in the direct wireless communication.

2. The communication apparatus according to claim 1, wherein the control unit determines that the communication using the first SSID is not being executed when there is a TCP connection.

3. The communication apparatus according to claim 1, wherein the control unit, in a case where the communication using the first SSID is being executed, displays a screen for inquiring with the second user whether to change to the second SSID associated with the identification information of the second user, and determines whether or not to change the first SSID to the second SSID according to an instruction given via the screen.

4. The communication apparatus according to claim 3, wherein the control unit displays a name of the first user on the screen.

5. The communication apparatus according to claim 1, wherein the at least one processor that executes the instructions stored in the memory device to cause the communication apparatus to further function as a storage unit configured to store an SSID and identification information of a user in association with each other,
wherein the setting unit obtains and sets the first SSID associated with the identification information of the first user, based on the storage unit.

6. The communication apparatus according to claim 5, wherein the control unit obtains the second SSID associated with the identification information of the second user and changes from the first SSID to the second SSID, based on the storage unit.

7. A method of controlling a communication apparatus capable of direct wireless communication for wireless LAN communication with an external apparatus without involving a relay apparatus and having an operation device that accepts an operation of a user, the method comprising:
obtaining identification information of a first user that operates the operation device;
setting a first SSID associated with the identification information of the first user as an SSID to be used in the direct wireless communication; and
if communication using the first SSID is not being executed when identification information of a second user that operates the operation device is obtained, changing the SSID to be used in the direct wireless communication from the first SSID to a second SSID associated with the identification information of the second user, and if the communication using the first SSID is being executed, not changing the SSID to be used in the direct wireless communication.

8. The method according to claim 7, wherein it is determined that the communication using the first SSID is not being executed in a case that there is a TCP connection.

9. The method according to claim 7, wherein, in a case where, when changing from the first SSID to the second SSID associated with identification information of the second user, the communication using the first SSID is being executed, a screen for inquiring with the second user whether or not to change to the second SSID associated with the identification information of the second user is displayed, and it is determined whether or not to change the first SSID to the second SSID according to an instruction given via the screen.

10. The method according to claim 9, further comprising displaying a name of the first user on the screen.

11. The method according to claim 7, wherein an SSID and identification information of a user are stored in a memory in association with each other, and in the setting, the first SSID associated with the identification information of the first user is obtained and set, based on information stored in the memory.

12. The method according to claim 11, wherein, when changing from the first SSID to the second SSID, the second SSID associated with the identification information of the second user is obtained, and changing from the first SSID to the second SSID is performed, based on information stored in the memory.

13. A non-transitory computer-readable storage medium storing a program for causing a processor to execute a method of controlling a communication apparatus capable of direct wireless communication for wireless LAN communication with an external apparatus without involving a relay apparatus and having an operation device that accepts an operation of a user, the method comprising:
obtaining identification information of a first user that operates the operation device;
setting a first SSID associated with the identification information of the first user as an SSID to be used in the direct wireless communication; and
if communication using the first SSID is not being executed when identification information of a second user that operates the operation device is obtained, changing the SSID to be used in the direct wireless communication from the first SSID to a second SSID associated with the identification information of the second user, and if the communication using the first SSID is being executed, not changing the SSID to be used in the direct wireless communication.
